(19) United States
(12) Patent Application Publication
(10) Pub. No.: US 2003/0130846 A1
(43) Pub. Date: Jul. 10, 2003

(54) Speech processing with hmm trained on tespar parameters

(76) Inventor: Reginald Alfred King, Wiltshire (GB)

Correspondence Address: JACOBSON HOLMAN PLLC, 400 SEVENTH STREET N.W., SUITE 600, WASHINGTON, DC, 20004, US

(21) Appl. No.: 10/203,621

(22) PCT Filed: Feb. 22, 2001
(86) PCT No.: PCT/GB01/00743

(30) Foreign Application Priority Data
Feb. 22, 2000 (GB) 0004095.6

(51) Int. Cl. G10L 15/14

(52) U.S. Cl. 704/256

(57) ABSTRACT

A method of signal modelling comprises inputting to a statistical signal modelling system the output of a deterministic modelling system to thereby effect a reduction in the overall computational overhead.

### FIELD OF THE INVENTION

The present invention relates to signal processing arrangements and more particularly to signal processing arrangements for use in speech recognition systems, language identifying systems and speech verification systems.

### BACKGROUND OF THE INVENTION

In the field of signal processing there can be considered to be two approaches to signal modelling. The first approach is known as a deterministic approach and the second approach is known as a statistical approach.

Deterministic modelling involves characterising the signal by known physical components. Statistical modelling utilises stochastic processes such as Gaussian, Poisson, and Markov processes to characterise real-world events that are too complex to be completely characterised by a few physical components.

Deterministic modelling includes the use of Waveform Shape Descriptors (WSDs) which in turn includes Time Encoding and Time Encoded Signal Processing and Recognition (TESPAR). TESPAR is described in the United Kingdom Patent Specification No's 2020,517 and 2,268,609 and European Patent Specification No 0141497.

In the field of speech recognition, language identification and speaker verification it is known to employ statistical signal modelling using Markov processes particularly that known as the Hidden Markov Model (HMM), to characterise real-world signals.

The primary benefits of using an HMM includes:

a) its effectiveness in capturing time varying signal characteristics;

b) its ability to model unknown signal dynamics statistically;

c) its computational tractability due to the inherent statistical property of the Markov process.

A more detailed disclosure of the use of HMM is to be found in “Pattern Recognition and Prediction with application to Signal Characterisation” by D. H. Kil and S. B. Slin in AIP press. ISBN 1-56396-477-5.

Whilst the use of HMM can provide a relatively high success rate in characterising signals, and in particular those employed in speech recognition and speaker verification, there is still a requirement for a higher percentage success rate.

One of the problems in achieving this higher percentage is that although improvements can be made to the above discussed prior art approach this gives rise to the problem of progressively increasing computational overhead.

The present invention is therefore concerned with improving the success rate of signal identification, utilising a statistical modelling process such as HMM without incurring an unacceptable level of computational overhead.

In the prior art utilising the aforementioned statistical modelling process such as HMM the input to the statistical modelling process is essentially an energy density spectrum in the frequency domain.

### BRIEF SUMMARY OF THE INVENTION

According to the present invention a method of signal modelling comprises inputting to a statistical signal modelling system in the frequency domain the output of a deterministic modelling system in the time domain.

By this arrangement the overall accuracy of a signal recognition system, typically speech recognition, is increased without incurring an unacceptable increased level of computational overhead.

### BRIEF DESCRIPTION OF THE DRAWINGS

How the invention will be carried out will now be described, by way of example only, with reference to the accompanying drawings in which;

FIG. 1 is a diagrammatic representation of a prior art signal processing arrangement;

FIG. 2 is similar to FIG. 1 but illustrating the essentials of a signal processing arrangement according to the present invention;

FIG. 3 is a more detailed representation of the prior art arrangement shown in FIG. 1;

FIG. 4 is similar to FIG. 3 but showing in more detail the arrangement shown in FIG. 2;

FIG. 5 illustrates three different waveforms which have the same spectrum.

FIG. 6 is similar to FIG. 2 illustrating another embodiment of the present invention.

FIG. 7 is a random speech waveform;

FIG. 8 represents the quantised duration of each segment of the waveform of FIG. 7;

FIG. 9 represents the maxima or minima occurring in each segment of the waveform of FIG. 7;

FIG. 10 is a symbol alphabet derived for use in an embodiment of the present invention;

FIG. 11 is a flow diagram of a voice recognition system according to the embodiment of the present invention;

FIG. 12 illustrates a variation on FIG. 11;

FIG. 13 shows a symbol stream for the word SIX generated in the system of FIGS. 11 and 12 to be read sequentially in rows left to right and tip to bottom;

FIG. 14 shows a two dimensional “A” matrix for the symbol stream of FIG. 14;

FIG. 15 shows a block diagram of the encoder part of the system of FIG. 11; and

FIG. 16 shows a flow diagram for generating the A matrix of FIG. 15;

The invention will be described in relation to its application to a speech recognition system but it has applications in other areas including language identification and speaker verification, i.e. speech processing generally. The invention may also have applications in other fields involving signal processing generally.

FIG. 1

This illustrates diagrammatically a typical prior art arrangement in which a statistical modelling process typically a Hidden Markov Model (HMM) 100 is employed to process short intervals of speech input at 110.

The statistical modelling process 100 has already had created in it, by means of a training phase, probability values against which the speech input at 110 is compared in order to obtain the best match.

The input to the HMM 100 is from a frequency domain energy density spectrum coding arrangement 120.

In the prior art arrangement of FIG. 1 the input speech data is transformed into some form of spectrogram, i.e. segmented into fixed time intervals of typically 10-20 ms. Energy density profiles for each such time slice are calculated across a number of pre-determined fixed frequency bands.

A commonly used form of HMM is that known as the N State Left to Right HMM model. The spectral time slices or “feature vectors” are computed at an approximate frame rate and passed to the Left to Right HMM model in order to indicate the sequence of states associated with the voice input.

The advantage of the N State Left to Right HMM model is its capability to readily model signals which have distinct time varying properties.

The frequency domain coding at 120 is typically achieved utilising a discrete Fourier transform.

The frequency domain representation of signals via the “energy density spectrum”, commonly referred to as the “spectrum” of a signal, has been the principal method of representing signal variations in the past. This method has employed the so-called “Fourier Transform” (FT) and in the digital domain the so-called “Discrete Fourier Transform” (DFT).

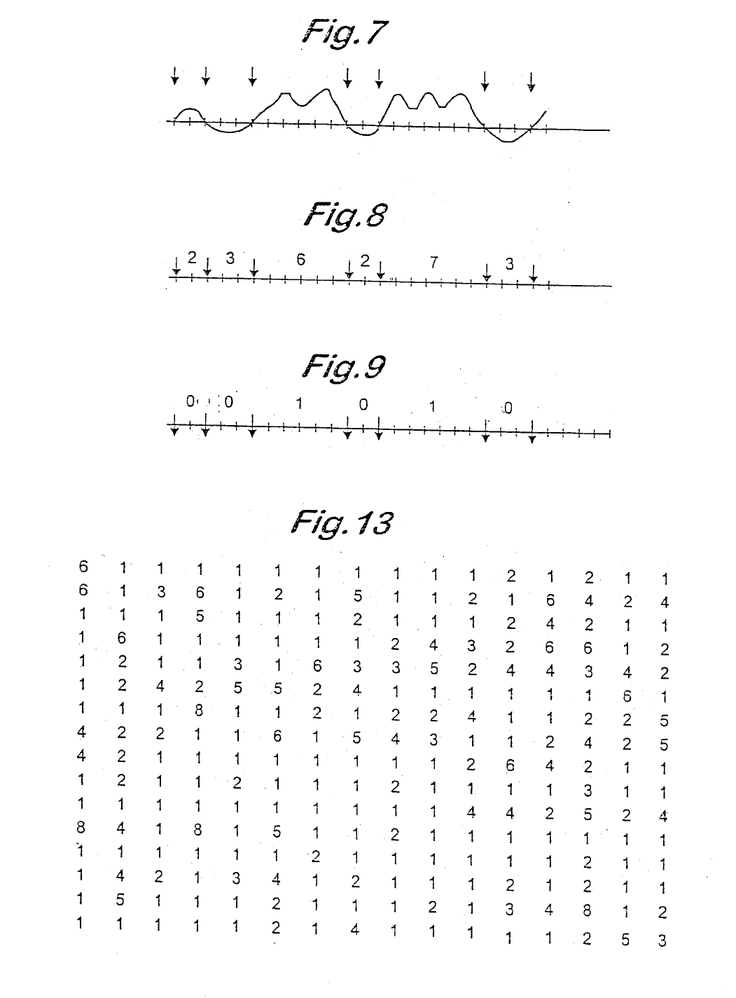

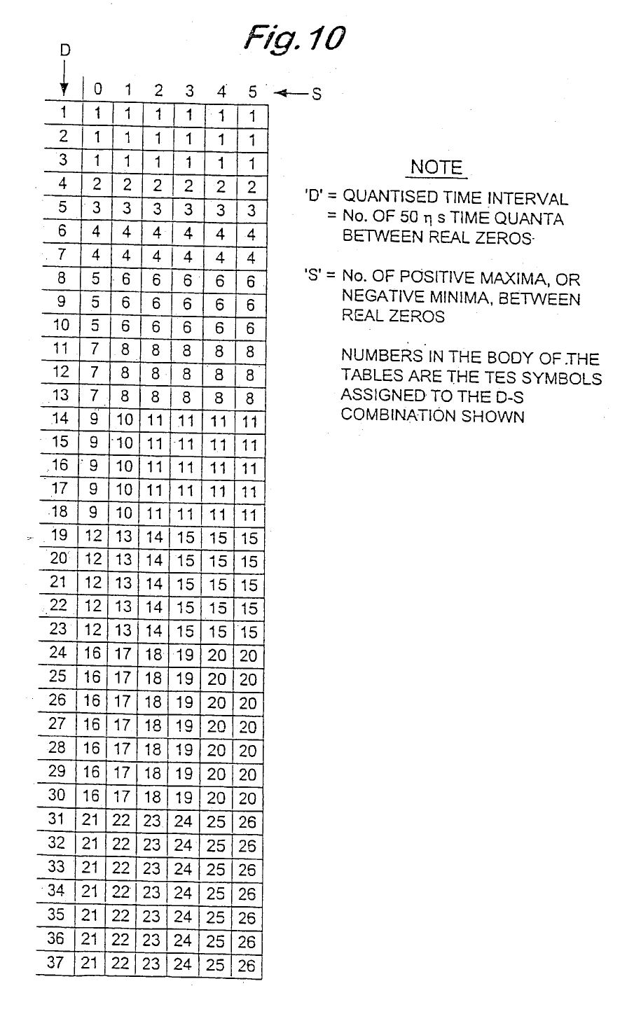

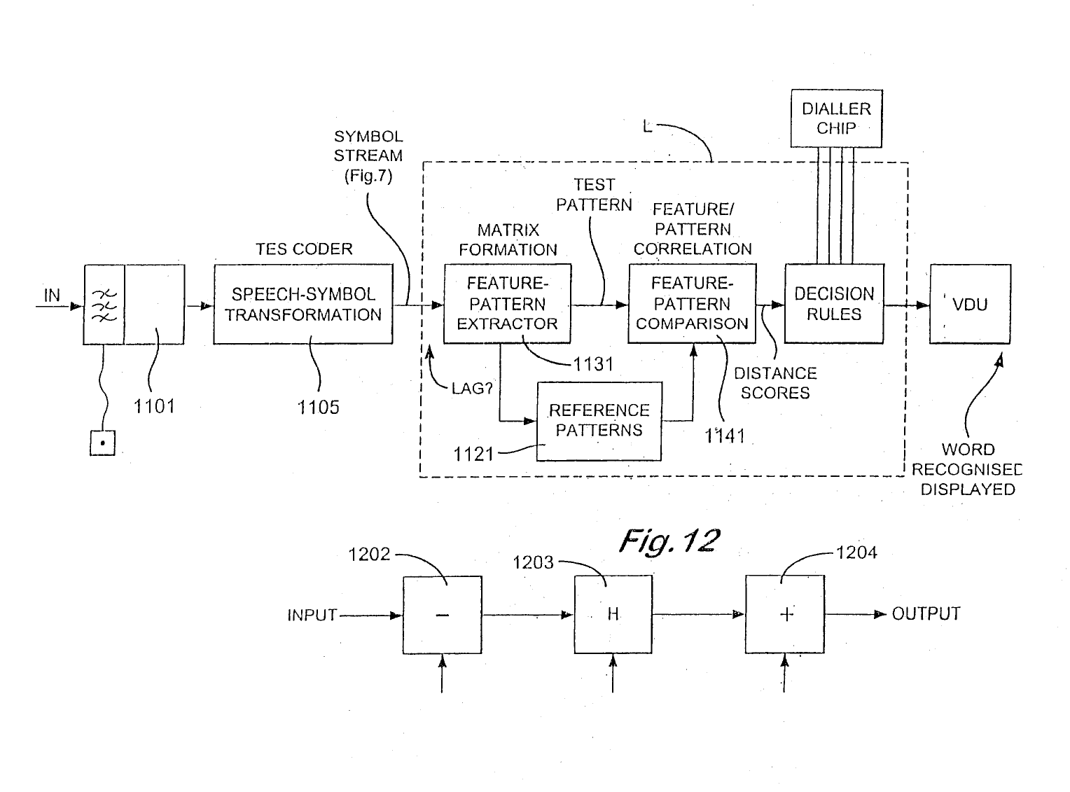

Use of the Fourier Transform for signal characterisation and modelling has its limitations. For example an infinite number of different signals can have the same spectrum, this being illustrated in FIG. 7.

In that figure three different shaped signals are indicated but each of these has the same spectral energy, i.e. the area under each of the three curves is substantially the same.

Thus the use of spectrograms and spectrographic feature vectors computed at appropriate frame rates are very limited representations of any signal for statistical signal modelling routines such as those employed in an HMM. The same comment applies to all statistical signal modelling routines.

One drawback associated with an HMM is its requirement for a lot of training data in order to facilitate the statistically valid estimation of model parameters. As the model size increases the amount of training data necessary to attain a statistically robust model increases rapidly. In general the quality of an HMM is constrained by the following practical considerations:

1) usually there is only a finite number of observation samples available; and

2) the size of the model depends on the physical phenominum it is being attempted to characterise.

Therefore, decreasing the model size to accommodate insufficient training samples may result in a large modelling error which is often not acceptable. Although various methods have been proposed in order to deal with the modelling error caused by an insufficient number of training samples these generally involve unacceptable increases in computational overhead.

Although the above description in relation to FIG. 1 and in particular the statistical modelling process 100 referred to as the Left and Right HMM, other versions of the HMM could be employed. In particular the so-called ergodic HMM could be utilised.

With the ergodic HMM modelling process the training data is divided into multiple time signals and a vector quantisation is performed on the entire observation sequence to find distinct clusters or states. This model derives the observation statistics based on training tokens that fall within each cluster and the observation probability density is modelled as either multivariant Gaussian (MVG) or Gaussian mixture models (GMM)s. Depending on how the observation probability is characterised, a state can consist of a cluster centroid or a centroid of a mixture consisting of multiple clusters. The choice between MVG and GMM depends upon the trade off between the modelling complexity in the GMM due to an increase in the number of observation model parameters and the computational complexity in the MVG due to the increase in the number of states.

Because of the flexible state transition characteristics for some applications the ergodic HMM model tends to provide a more robust estimate of the desired signal in comparison to the Left to Right HMM at the expense of higher computational cost. This extra cost is a factor which militates against the use of an ergodic HMM.

There would thus be significant benefits to be obtained if an ergodic HMM could be employed but without the above discussed associated unacceptable increase in computational overhead costs.

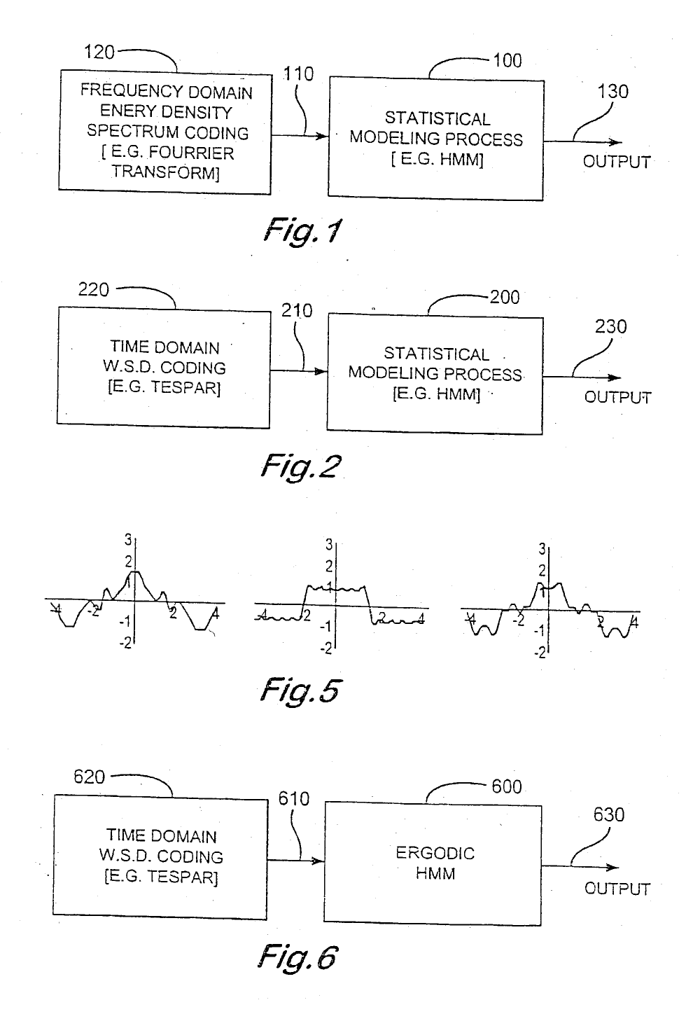

FIG. 2

In the method and system according to the present invention the known arrangement shown in FIG. 1 is replaced by an arrangement in which the input to the statistical modelling process 200 is provided by a time domain Waveform Shape Descriptor (WSD) coding system, typically that known as TESPAR.

Details of a TESPAR coding system can be found in UK patent specification. No. 2020,517 which document is hereby incorporated by reference.

Time Encoding Signal Processing and Recognition (TESPAR) coding processes produce signal modelling data derived from Waveform Shape Descriptors (WSD). By means of WSD coding different waveform shapes having the same energy levels will produce different signal characterisations such that the three waveforms shown in FIG. 5 will have differing WSD data representations.

Thus speech and other time varying waveforms may be simply characterised by means of TESPAR WSDs.

In the case of TES and TESPAR the waveform shapes are defined in terms of duration, shape and magnitude between the zero's of the waveform. For any given signal, e.g. speech, these shapes are vector quantised into a catalogue of standard shapes thus reducing the library of all possible individual shapes into an alphabet of thirty to forty entries for speech.

The processing power required to achieve this is several orders of magnitude less than that required to compute a Discrete Fourier Transform. (DFT) for a single spectral frame of a spectrogram.

The use of TESPAR shape descriptors enable the segmentation of acoustic events to be simply achieved as is described in more detail in European Patent Specification 0338035 which document is hereby incorporated by reference.

The present invention is based on the appreciation that matrices produced by, for example, a TESPAR coding arrangement 220 can be easily formed into ideal vectors for inputting to the statistical modelling processes (HMM) 200 both For training and robust recognition.

The matrices could be S or A or the higher dimensional so-called DZ matrix.

As far as the S and A matrices are concerned these may for example be So, Sm, Sa, Sb . . . etc., each network being created to emphasise oblique or orthogonal features of the waveform to be classified i.e. symbol frequency, amplitude, magnitude, duration etc. The DZ matrix may also be utilised to provide a pitch invariant data representation which is specifically and significantly advantageous for replying to an HMM for speaker independent continuous and connected word recognition.

Also, as indicated in United Kingdom Patent 2,268,609 (which document is hereby incorporated by reference) TESPAR data is ideally suited for coding time varying signals in order to provide optimum input to all artificial neural networks (ANN) algorithms. Thus TESPAR, as an example of waveform shaped descriptors (WSDs), enables supplementary ANN algorithms to be used effectively in for example, voice normalisation, noise reduction, and perameter estimation for these and other non-linear models.

The very economical data structures associated with WSD data enables multiple parallel classifications of oblique or orthogonal data sets to be derived. These data sets can be coupled in parallel to a data fusion algorithm such as for example simple vote taking, in order to enhance the performance of an HMM classifier.

The segmentation of acoustic signals using WSDs (see European Patent Specification 0338035) may be further enhanced by a variety of numerical filtering options post coding such as modal filtering or medium filtering to enhance signal segmentation as a means of improving the ability of the HMM to consistently classify the incoming signal.

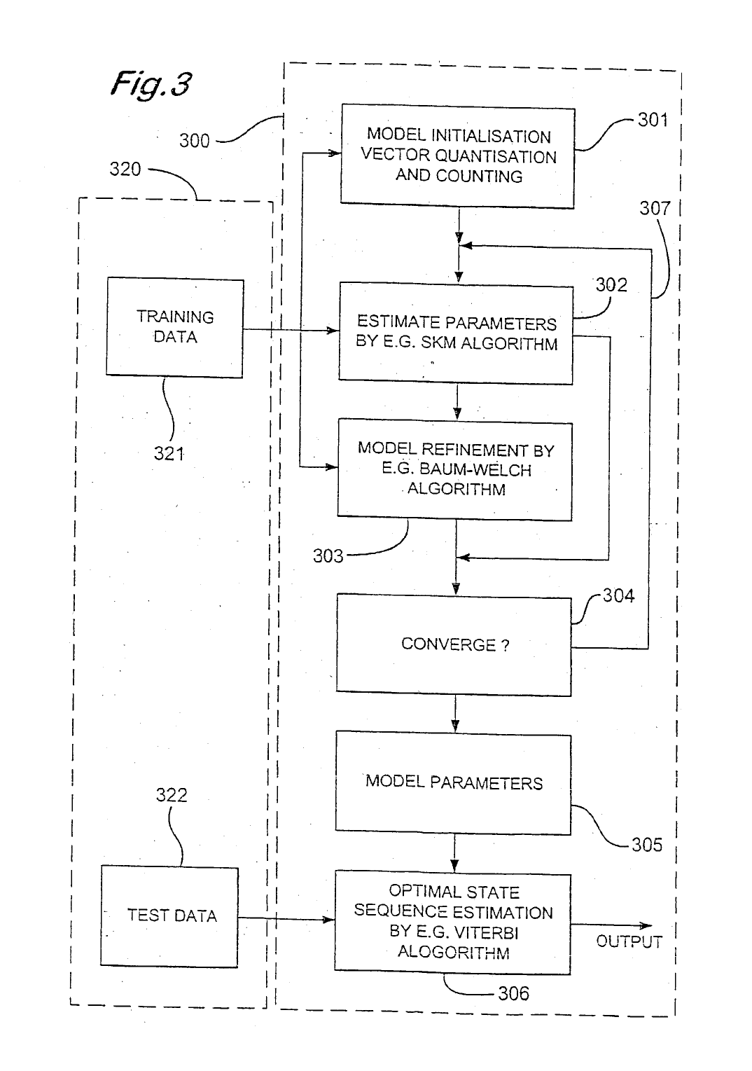

FIG. 3

In this Figure the block 300 is equivalent to 100 in FIG. 1 and the block 320 is equivalent to 120 in FIG. 1.

The block 300 represents an HMM that by means of training data entered by 321 is configured by means of a set of parameters to model the desired signal in some optimal sense.

These set of optimised model parameters are indicated at 305 and would then be input to an optimal state sequence estimator 306 into which the test data in question 322 is also input.

The conversion of the training data 321 to the model parameters at 305 will now be described.

The training data at 321 is divided into N distinct states and assigned observation vectors which have similar statistical properties to one of the N states. This takes place at 301.

A vector quantisation is employed for each state in order to form N clusters. Observation tokens are assigned to each cluster and these dictate the multivariate Gaussian probability density of each mode in the Gaussian mixture model (GMM) of M modes. Parameters of the GMM are estimated from observation tokens assigned to that particular state. The model parameters are computed by counting event and transition occurrences, this also taking place at 301.

The training procedure can be considered to be divided into two separate phases, the initialisation which has already been described with reference to 301 and the re-estimation which will now be described.

The initial parameter estimation process comprises partitioning of the observation vector space and counting the number of training sample occurrences in order to obtain crude estimates of signal statistics. At the re-estimation phase the model parameters are updated iteratively in order to maximise the value of the probability of observation. This is achieved by evaluating the probability of observation at each iteration until some convergence criteria are met. These convergence criteria have been indicated at 304 in FIG. 3.

The purpose of 302 and 303 is to refine the re-estimation procedure.

In general given a fixed set of training observations the optimal re-estimation solution that converges to the global maximum point is very difficult to attain due to the lack of an analytic solution.

It is therefore known to aim for a sub-optimal solution containing parameter estimates that converge to one of the local maxima. This can be achieved in a number of ways.

In the arrangement shown in FIG. 3 the re-estimation is effected by means of a segmental k-means (SKM) algorithm together with a Baum-Welch algorithm indicated at 303.

If after a particular iteration the conversion criteria at 304 are not met then the output from the Baum-Welch algorithm 303 is recycled via 307 to again be fed through the SKM algorithm 302 and the Baum-Welch algorithm 303. This iterative process is continued until the desired convergence criteria are met at 304 when the output is fed to 305.

The above described arrangement is known and a more detailed treatment of it, including the relevant mathematics, is to be found in Chapter 5 entitled “Hidden Markov Models” of the publication Pattern Recognition And Prediction with Applications to Signal Characterisation by David H. Kil and Frances B. Skin published by AIP Press, American Institute of Physics.

The test data input at 322 to the optimal state sequence estimator 306 is compared with the model parameters from 305.

At 306 the most likely state sequence is estimated, given an observation sequence 322 and a set of model parameters 305.

This is achieved by use of a Viterbi decoding algorithm based on dynamic programming. Again this arrangement is known from the prior art and more details concerning it can be found in the above mentioned publication by Kil and Skin.

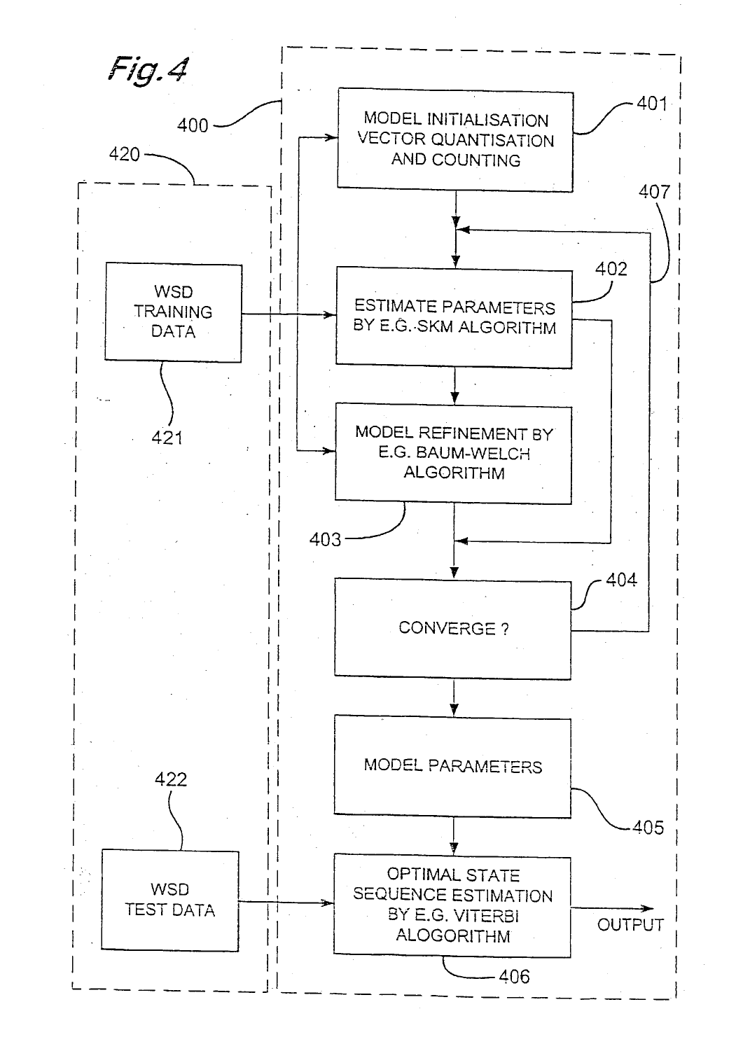

FIG. 4

This discloses an arrangement according to the present invention.

That part of the arrangement shown in FIG. 4 and identified by the reference numeral 400 and the reference numerals 401 to 407 is the same as the arrangement indicated at 300 and the reference numeral 301 to 307 in FIG. 3. Thus the arrangements indicated at 300 at FIG. 3 and 400 at FIG. 4 comprise a Hidden Markov Model (HMM).

However the known frequency domain energy density spectrum coding input 321, 322 of FIG. 3 is replaced by the time domain waveform shape descriptor (WSD) coding arrangement 420, 422.

FIG. 6

In the arrangement of FIG. 6 an ergodic HMM 600 replaces the unit indicated at 200 in FIG. 2. In FIG. 6 the unit 220 of FIG. 2 is represented by 620.

As indicated earlier the present invention is particularly useful in that it enables the higher computational cost of an ergodic HMM six hundred when compared to a left-to-right HMM, to be mitigated thus making it more attractive as a result of its inherent advantage over the left-to-right HMM as far as being able to provide a more robust estimate of the desired signal.

The ergodic HMM is sometimes referred to as a fully connected HMM. This is because every state can be reached by every other state in a finite number of steps. As a result, the state transition matrix A tends to be fully loaded with positive coefficients.

The ergodic HMM and the left-to-right HMM partition the time and observation vector space differently.

In the left-to-right HMM the training data is divided up into multiple time segments into which each time segment constitutes the state. The observation probability density for each state is derived from observations that belong to each time segment and is normally characterised by a Gaussian model.

In contrast with the ergodic HMM the training data is not divided up into multiple time segments but instead vector quantisation is performed on the entire observation sequence in order to find distinct clusters or states.

In the case of both an ergodic HMM and a left-to-right HMM SKM and Baum-Welch algorithms are employed for the purpose already indicated in connection with FIG. 3.

FIGS. 7 to 16

An example of a TESPAR voice recognition system will now be described with reference to FIGS. 7 to 16. Such a system can be found at 220 in FIG. 2 and 620 in FIG. 6.

Time encoded speech is a form of speech waveform coding. The speech waveform is broken into segments between successive real zeros. As an example FIG. 7 shows a random speech waveform and the arrows indicate the points of zero crossing. For each segment of the waveform the code consists of a single digital word. The word is derived from two parameters of the segment, namely its quantised time duration and its shape, The measure of duration is straightforward and FIG. 8 illustrates the quantised time duration for each successive segment—two, three, six etcetera.

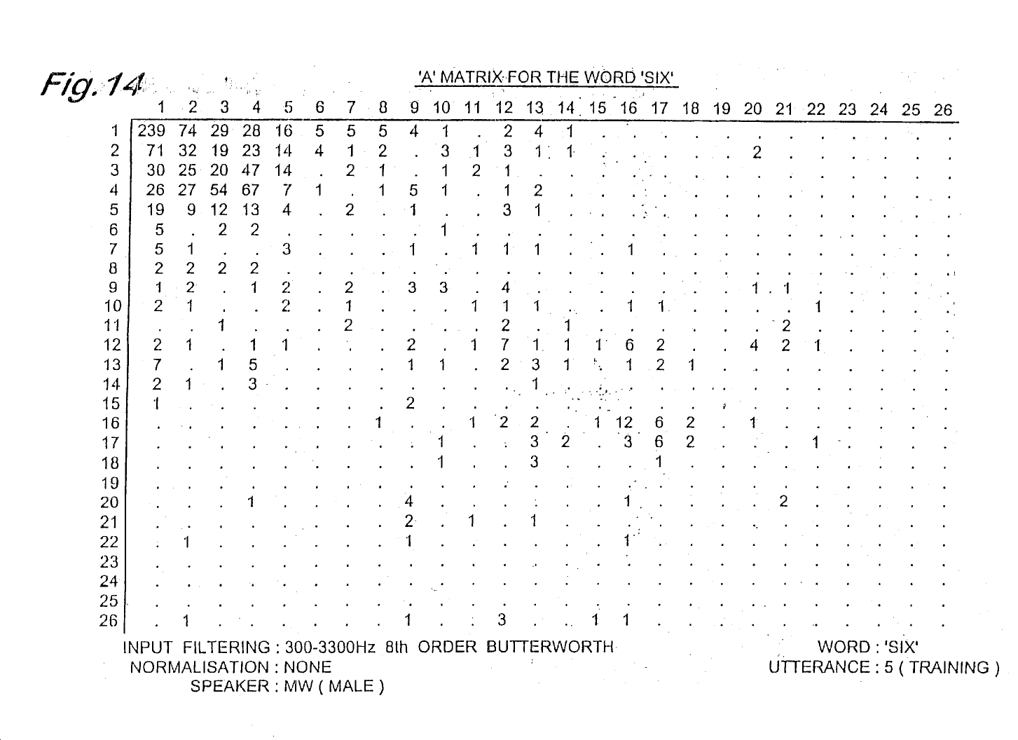

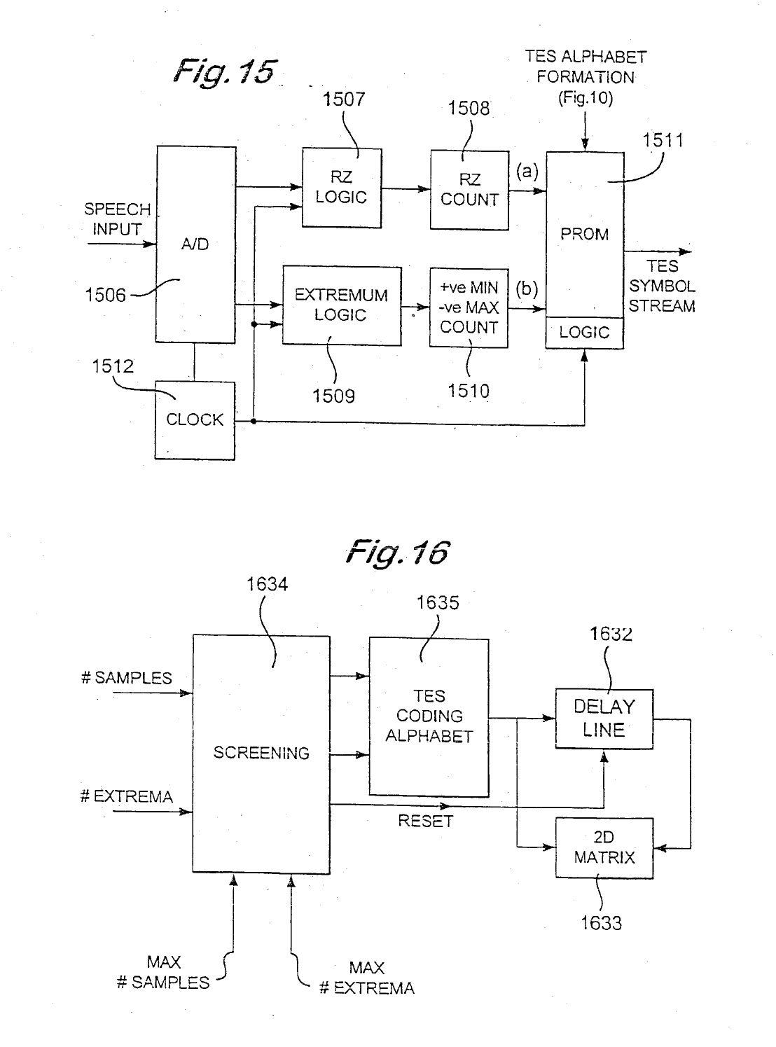

The preferred strategy for shape description is to classify wave segments on the basis of the number of positive minima or negative maxima occurring therein, although other shape descriptions are also appropriate. This is represented in FIG. 9—nought, nought, one, two, nought. These two parameters can then be compounded into a matrix to produce a unique alphabet of numerical symbols. FIG. 10 shows such an alphabet. Along the rows the “S” parameter is the number of maxima or minima and down the columns the D parameter is the quantised time duration. However this naturally occurring alphabet has been simplified based on the following observations. For economical coding it has been found acoustically that the number of naturally occurring distinguishable symbols produced by this process may be mapped in a non-linear fashion to form a much smaller number (“Alphabet”) of code descriptors (or Wave Shape Descriptors: WSD) and such code or event descriptors produced in the time encoded speech format are used for Voice Recognition. If the speech signal is band limited—for example to 3.5 kHz—then some of the shorter events cannot have maxima or minima. In the preferred embodiment quantising is carried out at twenty Kbits samples, i.e. three twenty Kbit samples represent one half cycle at 3.3 kHz and thirty twenty Kbit samples represent one half cycle at three hundred HZ.

Another important aspect associated with the time encoded speech format is that it is not necessary to quantise the lower frequencies so precisely as the higher frequencies.

Thus referring to. FIG. 10, the first three symbols (1, 2 and 3), having three different time durations but no maxima and minima, are assigned the same descriptor (1), symbols 6 and 7 are assigned the same descriptor (4), and symbols 8, 9 and 10 are assigned the same descriptor (5) with no shape definition and the descriptor (6) with one maximum or minimum. Thus in this example one ends up with a description of speech in about twenty-six descriptors.

It is now proposed to explain how these descriptors are used in Voice Recognition and as an example it is appropriate at this point to look at the descriptors defining a word spoken by a given speaker. Take for example the word “SIX”. In FIG. 14 is shown part of the time encoded speech symbol stream for this word spoken by the given speaker and this represents the symbol stream which will be produced by an encoder such as the one to be described with reference to FIGS. 11 and 12, utilising the alphabet shown in FIG. 10.

FIG. 14 shows a symbol stream for the work “SIX”, and FIG. 15 shows a two dimensioned plot or “A” matrix of time encoded speech events for the word “SIX”. Thus the first number 239 represents the total number of descriptors (1) followed by another descriptor (1). In FIG. 14 “1” represents the number of descriptors (2) followed each by a descriptor (1) and “4” represents the total number of descriptors (1) followed by a (2) and so on.

This matrix gives a basic set of criteria used to identify a word or a speaker. Many relationships between the events comprising the matrix are relatively immune to certain variations in the pronunciation of the work. For example the location of the most significant events in the matrix would be relatively immune to changing the length of the word from “SIX” (normally spoken) to “SI . . . IX”, spoken in more long drawn-out manner. It is merely the profile of the time encoded speech events as they occur, which would vary in this case, and other relationships would identify the speaker.

It should be noted that the TES symbol stream may be formed to advantage into matrices of higher dimensionality and that the simple two dimensional “A”-matrix is described here for illustration purposed only.

Referring to FIGS. 11 and 12 there is shown a flow diagram of a voice recognition system.

The speech utterance from a microphone tape recording or telephone line is fed at “IN” to a pre-processing stage 1101 which includes filters to limit the spectral content of the signal from for example three hundred Hz to 3.3 kHz. Dependent on the characteristics of the microphone used, some additional pre-processing such as partial differentiation/integration may be required to give the input speech a predetermined spectral content. AC coupling.DC removal may also be required prior to time encoding the speech (TES coding).

FIG. 12. shows one arrangement in which, following the filtering, there is a DC removal stage 1202, a first order recursive filter 1203 and an ambient noise DC threshold sensing stage 1204 which responds only if the DC threshold, dependent upon ambient noise, is exceeded.

The signal then enters a TES coder 1105 and one embodiment of this is shown in FIG. 15. Referring to FIG. 15 the band-limited and pre-processed input speech is converted into a TES symbol stream via a A/D converter 1506 and suitable logic RZ logic 1507, RZ counter 1508, extremum logic 1509 and positive minimum and negative maximum counter 1510. A programmable read-only-memory 1511, and associated logic acts as a look-up table containing the TES alphabets of FIG. 10 to produce an “n” bit TES symbol stream in response to being addresses by a) the count of zero crossings and b) the count of positive minimums and negative maximums such for example as shown for part of the word “SIX” in FIG. 14.

Thus the coding structure of FIG. 10 is programmed into the architecture of the TES coder 1105. The TES coder identifies the DS combinations shown in FIG. 10, converts these into the symbols shown appropriately in FIG. 10 and outputs them at the output of the coder 5 and they then form the TES symbol stream.

A clock signal generator 12 synchronises the logic.

From the TES symbol stream is created the appropriate matrix feature-pattern extractor 1131, FIG. 11, which in this example is a two dimensional “A” matrix. The A-matrix appears in the Feature Pattern Extractor box 1131. In this case the pattern to be extracted or the feature to be extracted is the A matrix. That is the two dimensional matrix representation of the TES symbols. At the end of the utterance of the word “six” the two dimensional A matrix which has been formed is compared with the reference patterns previously generated and stored in the Reference Pattern block 1121. This comparison takes place in the Feature Pattern Comparison block 1141, successive reference patterns being compared with the test pattern or alternatively the test pattern being compared with the sequence of reference patterns, to provide a decision as to which reference pattern best matches the test pattern. This and the other functions shown in the flow diagram of FIG. 11 and within the broken line L are implemented in real time on a suitable computer.

A detailed flow diagram for the matrix formation 1131 is shown in FIG. 16 where boxes 1634 and 1635 correspond to the speech symbol transformation or TES coder 1105 of FIG. 11 and the feature pattern extractor or matrix formation box 1131 of FIG. 11 corresponds to boxes 1632 and 1633 of FIG. 16. The flow diagram of FIG. 16 operates as follows:

1. Given input sample [xₙ], define “centre clipped” input:

[n′ₙ]=if x≠0

=+1, if xₙ=0 and x′ₙ₋₁>0

=−1. if xₙ=0 and x′ₙ₋₁>0

2. Define an “epoch” as consecutive samples of like sign

3. Define “Difference” [dₙ]

dₙ=x′ₙ=x′ₙ₋₁

4. Define “Extremum” at n with value e if

sgn(dₙ+₁) sgn(dₙ)≠e=s_{n′}0 accorded+ve sign.

5. From the sequence of extrema, delete those pairs whose absolute difference in value is less that a given “fluctuation error”.

6. The output from the TES analysis occurs at the first sample of the new epoch, It consists of the number of contained samples and the number of contained extrema.

7. If both numbers fall within given ranges, a TES number is allocated according to a simple mapping. This is done in box 1634 “Screening” in FIG. 16.

8. If the number of extrema exceeds the maximum, then this maximum is taken as the input. If the number of extrema is less than one, then the event is considered as arising from background noise (within the value of the [+ve] fluctuation error) and the delay line is cleared.

9. If the number of samples is greater that the maximum permitted then the delay line is also cleared.

10. The TES numbers are written to a resettable delay line. If the delay line is full, then a delayed number is read and the input/output combination is accumulated into N=2. Once reset, the delay line must be reaccumulated before the histogram is updated.

11. The assigned number of highest entries (“Significant events”) are selected from the histogram and stored with their matrix co-ordinates; in this example of “A” matrix these are two dimensional co-ordinates to produce for example FIG. 13.

The twenty-six symbol alphabet used in the voice recognition system is designed for a digital speech system. The alphabet is structured to produce a minimum bit-rate digital output from an input speech waveform, band-limited from three hundred Hz to 3.3 kHz. To economise on bite-rate, this alphabet maps the three shortest speech segments of duration one, two and three, time quanta, into the single TES symbol “1”. This is a sensible economy for digital speech processing, but for voice recognition, it reduces the options available for discriminating between a variety of different short symbol distributions usually associated with unvoiced sounds.

It has been determined that the predominance of “1” symbols resulting from the alphabet and this bandwidth may dominate the ‘A’ matrix distribution to an extent which limits effective discrimination between some words, when comparing using the simpler distance measures. In these circumstances, more effective discrimination may be obtained by arbitrarily excluding “1” symbols and “1” symbol combinations from the ‘A’ matrix. Although improving voice recognition scores, this effectively limits the examination/comparison to events associated with a much reduced bandwidth of 2.2 kHz/. (0.3 kHz-2.5 kHz). Alternatively and to advantage the TES alphabet may be increased in size to include descriptors for these shorter events.

Under conditions of high background noise alternative TES alphabets could be used to advantage; for example pseudo zeros (PZ) and Interpolated zeros (IZ).

As a means for an economical voice recognition algorithm, a very simple TES converter can be considered which produces a TES symbol stream from speech without the need for an A/D converter. The proposal utilises Zero Crossing detectors, clocks, counters and logic gates. Two Zero Crossing detectors (ZCD) are used, one operating on the differentiated speech signal.

The d/dt output can simply provide a count related to the number of extremum in the original speech signal, over any specified time interval. The time interval chosen is the time between the real zeros of the signal viz. The number of clock periods between the outputs of the ZCD associated with the under differentiated speech signal, These numbers may be paired and manipulated with suitable logic to provide a TES symbol stream.

1. A method of signal modelling comprises inputting to a statistical signal modelling system the output of a deterministic modelling system to thereby effect a reduction in the overall computational overhead.

2. A method as claimed in claim 1 in which the statistical signal modelling system comprises a Hidden-Markov-Modelling system (HMM).

3. A method as claimed in claims 1 or 2 in which the deterministic modelling system comprises a Waveform-Shape-Descriptor system (WSD).

4. A method as claimed in claim 3 in which the WSD system comprises a Time Encoding and Time Encoded Signal processing and Recognition (TESPAR) system.

5. A method as claimed in claim 2 in which the HMM is an N state left-to-right HMM model.

6. A method as claimed in claim 2 in which the HMM is an ergodic HMM model.

7. A method as claimed in claim 1 in which the statistical system utilises either a Gaussian or Poisson process.

8. A method as claimed in claim 7 in which the Gaussian process is either a multivariant Gaussian (MVG) or a Gaussian mixture model (GMM).

9. A speech recognition system incorporating the method as claimed in any one of claims 1-8.

10. A language identifying system utilising the method as claimed in any one of the claims 1-8.

11. A speaker verification system utilising the method as claimed in anyone of claims 1-8.

12. A method of signal modelling substantially as hereinbefore described with reference to and as shown in the accompanying drawings.

13. A system of signal modelling substantially as hereinbefore described with reference to and as shown in the accompanying drawings.
